(19) United States
(12) Patent Application Publication
(10) Pub. No.: US 2021/0072711 A1
(43) Pub. Date: Mar. 11, 2021

(54) OPTIMIZER OPTIMIZATION METHOD AND NON-TRANSITORY COMPUTER-READABLE STORAGE MEDIUM

(71) Applicant: FUJITSU LIMITED, Kawasaki-shi (JP)

(72) Inventor: Daisuke Kushibe, Kawasaki (JP)

(73) Assignee: FUJITSU LIMITED, Kawasaki-shi (JP)

(21) Appl. No.: 17/010,514

(22) Filed: Sep. 2, 2020

(30) Foreign Application Priority Data
Sep. 6, 2019 (JP) 2019-162826

(51) Int. Cl. G05B 15/02; G01N 25/00; G06N 10/00

(52) U.S. Cl. CPC G05B 15/02; G06N 10/00; G01N 25/005

(57) ABSTRACT

An optimizer includes a memory and a processor coupled to the memory and configured to obtain specific heat information indicating a relationship between a specific heat indicating a degree of variation of energy according to a temperature variation and a temperature, and determine a plurality of temperature values to be respectively set for a plurality of replicas when an optimum value of energy functions is obtained by a replica exchange method based on the specific heat information.

### CROSS-REFERENCE TO RELATED APPLICATION

This application is based upon and claims the benefit of priority of the prior Japanese Patent Application No. 2019-162826, filed on Sep. 6, 2019, the entire contents of which are incorporated herein by reference.

### FIELD

The embodiments discussed herein are related to an optimizer, an optimization method and a non-transitory computer-readable storage medium.

### BACKGROUND

There has been a problem that frequently occurs in the fields of natural science and social science, which is a global minimum obtainment problem (or referred to as a combinatorial optimization problem) for obtaining the global minimum (or a combination of values of state variables of evaluation functions from which the global minimum is obtained) of evaluation functions (also referred to as energy functions). Recently, the movement of formulating such a problem by the Ising model, which is a model indicating the behavior of spins of magnetic substances. The technical basis of this movement is implementing of Ising quantum computers. The Ising quantum computers are expected to solve a combinatorial optimization problem of multi-variables in realistic time, which is a weak point of von Neumann computers. Meanwhile, there have been also developed optimizers in which the Ising computers are implemented with electronic circuits (for example, see NPL 1 (Sanroku Tsukamoto, Motomu Takatsu, Satoshi Matsubara and Hirotaka Tamura, “An Accelerator Architecture for Combinatorial Optimization Problems”, FUJITSU Sci. Tech. J., Vol. 53, No. 5, September, 2017, pp. 8-13)).

There is a method of obtaining the global minimum of Ising energy functions by using the Markov chain Monte Carlo method (hereinafter, referred to as the MCMC method or the MCMC computation) as a method of computing the global minimum obtainment problem using the Ising model. In the MCMC computation, usually, the state variables of the energy functions are updated (state transition) with a transition probability according to the Boltzmann distribution. However, the energy functions include many local minima to be local solutions, and if a solution is once trapped by the local solution, the probability of escaping from the local solution is considerably low. The simulated annealing method (hereinafter, abbreviated as the SA method) (for example, see Japanese Patent Nos. 6465223 and NPL 1, 2 (S. Kirkpatrick, C. D. Gelatt Jr, M. P. Vecchi, “Optimization by Simulated Annealing”, Science, Vol. 220, No. 4598, 13 May, 1983, pp. 671-680), and 3 (Constantino Tsallis, Daniel A. Stariolo, “Generalized simulated annealing”, Physica A, 233, 1996, pp. 395-406)) is known as a method of facilitating the escaping from the local solution. There is also known a method such as the replica exchange method (also referred to as the expanded ensemble method) (for example, see Japanese Patent Nos. 6465231 and NPL 4 (Koji Hukushima and Koji Nemoto, “Exchange Monte Carlo Method and Application to Spin Glass Simulations”, J. Phys. Soc. Jpn, Vol. 65, No. 6, June, 1996, pp. 1604-1608)) as the method of escaping from the local solution.

The SA method is a method of eventually obtaining the global minimum of the energy functions by gradually decreasing a value of a temperature parameter (comparable to decreasing the temperature) included in an expression for determining the transition probability according to a predetermined schedule. The replica exchange method is a method of setting temperature parameters of different values for multiple replicas to perform the MCMC computation independently in each replica and exchanging the values of the temperature parameters (or state variables) between the replicas with a predetermined exchange probability. In the replica exchange method, the temperature of each replica is moved randomly in a temperature space. Such a random variation of temperature is called a random walk.

In the SA method, if a solution is once trapped by a local solution, it is difficult to expand a search range to another search space different from that of the local solution. On the other hand, in the replica exchange method, it is possible to perform sampling of both a low temperature setting and a high temperature setting for each of multiple replicas, and the probability of escaping from a local solution when a solution is once trapped by the local solution is high.

Related techniques are disclosed in for example International Publication Pamphlet Nos. WO 2016/133002 and 2017/183075, Japanese Laid-open Patent Publication No. 2017-049971, and Japanese Patent Nos. 6465223 and 6465231.

### SUMMARY

According to an aspect of the embodiments, an apparatus includes an optimizer includes a memory, and a processor coupled to the memory and configured to obtain specific heat information indicating a relationship between a specific heat indicating a degree of variation of energy according to a temperature variation and a temperature, and determine a plurality of temperature values to be respectively set for a plurality of replicas when an optimum value of energy functions is obtained by a replica exchange method based on the specific heat information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an optimizer according to a first embodiment;

FIG. 2 is a diagram illustrating an example of hardware of an optimizer;

FIG. 3 is a diagram illustrating an example of an energy landscape;

FIG. 4 is a diagram illustrating an overview of the replica exchange method;

FIG. 5 is a diagram illustrating an example of temperature transitions of replicas in the replica exchange method;

FIG. 6 is a diagram illustrating an example of computation results of energies in the replica exchange method;

FIG. 7 is a diagram illustrating an example of temporal variations of energies of two replicas of different temperatures;

FIG. 8 is a diagram illustrating an example of temperature variations of specific heats;

FIG. 9 is a diagram illustrating a relationship between a temperature interval coefficient and a temperature of a replica;

FIG. 10 is a block diagram illustrating functions of the optimizer;

FIG. 11 is a flowchart illustrating an example of procedures of energy global minimum obtainment processing;

FIG. 12 is a flowchart illustrating an example of procedures of specific heat computation processing;

FIG. 13 is a flowchart illustrating an example of procedures of temperature optimization processing;

FIG. 14 is a diagram illustrating an example of comparing solutions of cases in which the number of computation steps is increased and a case in which the temperature optimization is performed;

FIG. 15 is a diagram illustrating an example of comparing solutions of cases in which the number of replicas is increased and the case in which the temperature optimization is performed;

FIG. 16 is a flowchart illustrating an example of procedures of the energy global minimum obtainment processing in a third embodiment; and

FIG. 17 is a diagram illustrating an example of sampling information for finding a temperature row with which the replica exchange is optimized.

### DESCRIPTION OF EMBODIMENTS

In the replica exchange method, it is possible to perform the replica exchange between the adjacent replicas when the replicas are arranged in the order of the set temperatures. Whether the replica exchange is performed between the replicas on which the replica exchange is able to be performed is determined probabilistically according to a replica exchange probability. When the replica exchange probabilities of multiple combinations of the replicas on which the replica exchange is able to be performed are uneven, the random walk of the replicas in the temperature space may not be performed properly. When the random walk is not performed properly, the sampling space is not expanded, and it is difficult to obtain the global minimum of the energies. However, it is not easy to even up the replica exchange probabilities because the replica exchange probability is determined based on an exponential attenuation of a product of the energy difference and the inverse temperature difference between the exchange target replicas.

In one aspect, an object of the embodiments is to enhance the evenness of the replica exchange probabilities.

Hereinafter, embodiments will be described with reference to the drawings. Each of the embodiments may be implemented by combining multiple embodiments with each other without any contradiction.

### First Embodiment

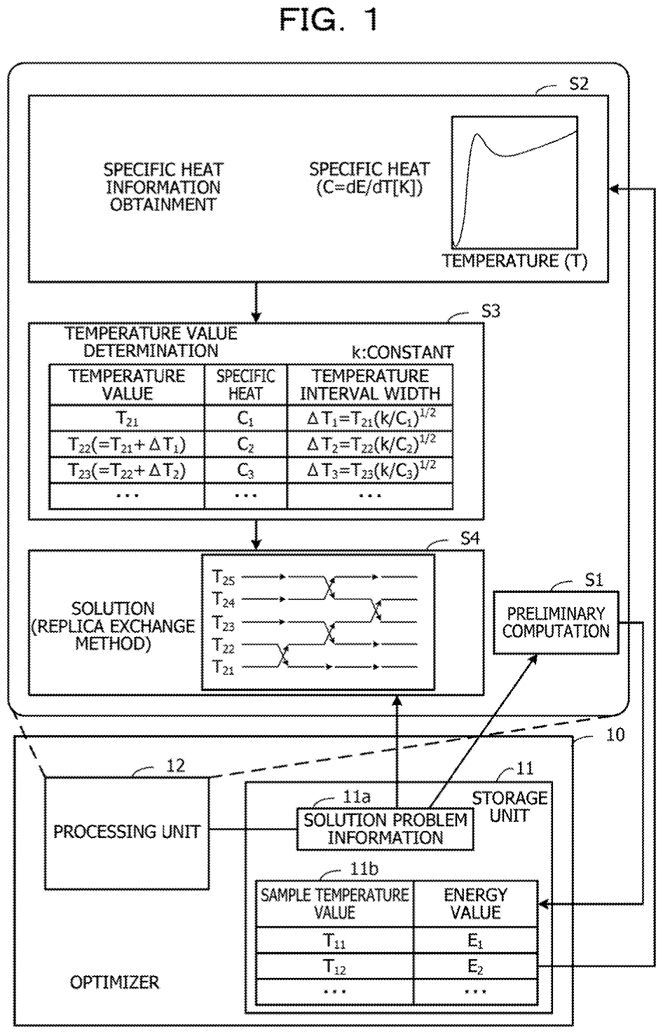

FIG. 1 is a diagram illustrating an example of an optimizer according to a first embodiment. An optimizer 10 includes a storage unit 11 and a processing unit 12. Note that optimizer may be described as optimization apparatus.

The storage unit 11 stores values of state variables included in evaluation functions (hereinafter, referred to as energy functions) converted from a problem, values of the evaluation functions (hereinafter, referred to as energies) corresponding to the values of the state variables, and the like. The storage unit 11 is a volatile storage device such as a random-access memory (RAM) or a non-volatile storage device such as a hard disk drive (HDD) and a flash memory.

The processing unit 12 obtains an optimum value of the energy functions by repeating processing of updating the values of the state variables by the MCMC method. The optimum value may be, for example, the global minimum or the global maximum. Hereinafter, a case in which the optimum value is the global minimum is described. The processing unit 12 is a processor such as a central processing unit (CPU), general-purpose computing on graphics processing units (GPGPU), and a digital signal processor (DSP). The processing unit 12 may include an electronic circuit for a dedicated use such as an application-specific integrated circuit (ASIC) and a field-programmable gate array (FPGA). The processor executes a program stored in a memory such as the RAM. For example, a control program of the optimizer 10 is executed. A set of multiple processors may be called a “multiprocessor” or simply called a “processor” in some cases.

The storage unit 11 includes solution problem information 11a indicating a global minimum obtainment problem for obtaining the global minimum of the energy functions and thermal equilibrium state information 11b. The solution problem information 11a includes, for example, an energy function as a solution target, an initial value of a state variable set to the energy function, and the like. The thermal equilibrium state information 11b includes, for example, energy values (E₁, E₂, . . . ) in a thermal equilibrium state of respective sample temperature values (T₁₁, T₁₂, . . . ) corresponding to the multiple sample temperature values (T₁₁, T₁₂, . . . ). The energy values (E₁, E₂, . . . ) are, for example, obtained by solving the energy functions at the multiple sample temperature values (T₁₁, T₁₂, . . . ), respectively.

The thermal equilibrium state information 11b may include multiple energy values corresponding to a single sample temperature value, the energy values being calculated by computing the energy functions repeatedly in the thermal equilibrium state at the sample temperature value. The thermal equilibrium state information 11b may include an average value of the multiple energy values corresponding to a single sample temperature value, the energy values being calculated by computing the energy functions repeatedly in the thermal equilibrium state at the sample temperature value.

First, as preliminary computation, the processing unit 12 repeats computation of the energy functions at the respective multiple sample temperature values (T₁₁, T₁₂, . . . ) and stores the energy values (E₁, E₂, . . . ) after being set in the thermal equilibrium state in the storage unit 11 as the thermal equilibrium state information 11b (step S1).

Next, the processing unit 12 obtains specific heat information indicating a relationship between a specific heat (C=dE/dT[K]) indicating a degree of variation of energy according to the temperature variation and a temperature (T) (step S2). For example, the processing unit 12 calculates the specific heat information indicating the relationship between the specific heat (C=dE/dT[K]) and the temperature (T) based on the thermal equilibrium state information 11b. For example, the processing unit 12 generates as the specific heat information an interpolation formula for interpolating specific heats respectively corresponding to two sample temperature values (T₁₁, T₁₂, . . . ) adjacent to each other when the multiple sample temperature values (T₁₁, T₁₂, . . . ) are arranged in the order of the magnitude of the values.

Next, based on the calculated specific heat information, the processing unit 12 determines multiple temperature values (T₂₁, T₂₂, T₂₃, . . . ) to be respectively set to multiple replicas when obtaining the global minimum of the energy functions by the replica exchange method (step S3). For example, the processing unit 12 determines the multiple temperature values to be set to respective multiple replicas such that an interval between temperature values in a first temperature range is narrower than an interval of temperature values in a second temperature range in which the specific heat is smaller than that of the first temperature range.

For example, the processing unit 12 calculates temperature interval widths (ΔT₁, ΔT₂, ΔT₃ . . . ) based on a temperature interval width calculation formula by which the values become smaller as the specific heats (C₁, C₂, C₃, . . . ) become greater. For example, the processing unit 12 uses an expression of multiplying a square route of a value, which is obtained by multiplying an inverse of the specific heat by a constant k (k is a positive real number), by each of the temperature values (T₂₁, T₂₂, T₂₃, . . . ) as the temperature interval width calculation formula for the corresponding one of the temperature value (T₂₁, T₂₂, T₂₃, . . . ). The method of calculating the constant k is described in detail in a second embodiment (see Expression (17) and the like).

For example, the processing unit 12 calculates the temperature interval width corresponding to the specific heat at an m-th temperature value (m is an integer of 1 or greater) in the ascending order of temperature based on the temperature interval width calculation formula. The processing unit 12 then determines a temperature higher than the m-th temperature value by the calculated temperature interval width as an m+1-th temperature value in the ascending order of temperature.

For example, the temperature value T₂ of the lowest temperature is specified as an initial value in advance. In this process, the processing unit 12 computes a temperature interval width ΔT₁=T₂₁(k/C₁)^{1/2} at the temperature value T₂₁. Next, the processing unit 12 determines a value (T₂₁+ΔT₁) obtained by adding the temperature interval width ΔT₁=T₂₁(k/C₁)^{1/2} to the temperature value T₂₁ as the second temperature value Tn. Thereafter, the processing unit 12 determines the temperature values in the same way in the ascending order of temperature.

The processing unit 12 then sets the multiple temperature values (T₂₁, T₂₂, T₂₃, . . . ) for the multiple replicas respectively and obtains the global minimum of the energy functions by the replica exchange method (step S4).

In this way, it is possible to enhance the evenness of the replica exchange probability. For example, when the temperature intervals between the replicas are fixed, the replica exchange probabilities in a temperature range of high specifics heat are lower than that in a temperature range of low specific heats. On the other hand, the narrower the temperature intervals between the replicas, the higher the replica exchange probabilities. Thus, the optimizer 10 enhances the evenness of the replica exchange probabilities by narrowing the temperature intervals between the replicas as the specific heats in a temperature range are higher.

With the evenness of the replica exchange probabilities improved, the replicas are able to perform the random walk properly in the temperature space. Consequently, the sampling space is expanded, and the accuracy of obtaining a solution during the obtainment of the global minimum of the energy functions is enhanced.

The processing unit 12 may also perform optimization of the sample temperature values based on the determined temperature values. For example, after determining the multiple temperature values, the processing unit 12 changes the multiple sample temperature values to values same as the determined temperature values. The processing unit 12 then repeats the computation of the energy functions at the respective multiple sample temperature values after the changing and updates the thermal equilibrium state information 11b based on the energy values after being set in the thermal equilibrium state. In this way, it is possible to reduce errors of the specific heats at the temperature values and to obtain accurate temperature values. With the accuracy of the temperature values improved, it is possible to perform the obtainment of the global minimum of the energy functions accurately as well.

### Second Embodiment

Next, the second embodiment is described. In the second embodiment, the global minimum (or a combination of values of the state variables from which the global minimum is obtained) of the Ising energy functions converted from the problem is obtained by the replica exchange method using an optimizer.

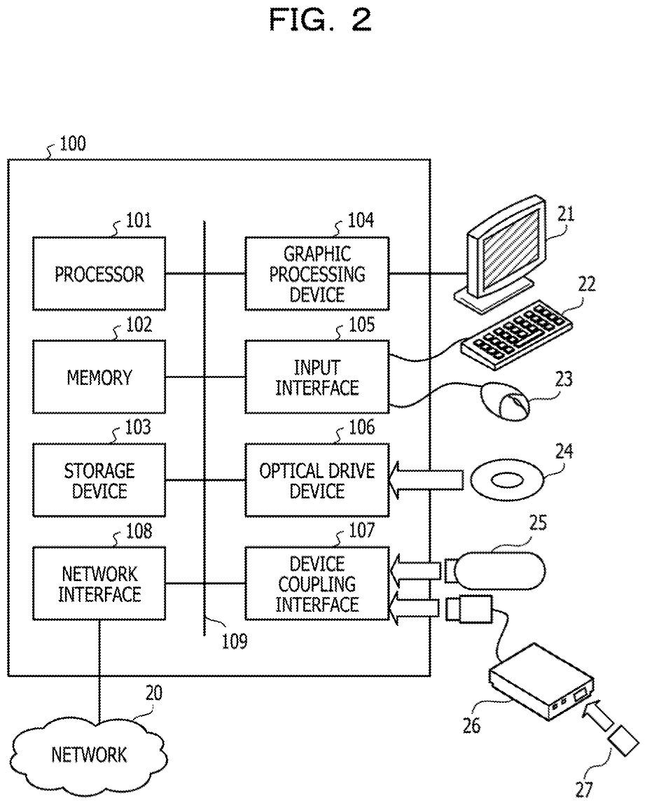

FIG. 2 is a diagram illustrating an example of hardware of an optimizer. An optimizer 100 is, for example, a computer, and a processor 101 controls overall the device. The processor 101 is coupled to a memory 102 and multiple peripherals through a bus 109. The processor 101 may be a multiprocessor.

The memory 102 is used as a main storage device of the optimizer 100. The memory 102 temporarily stores at least a part of a program and an application program of an operating system (OS) executed by the processor 101. The memory 102 stores various pieces of data used for processing by the processor 101. A volatile semiconductor storage device such as a RAM is used as the memory 102, for example.

The peripherals coupled to the bus 109 may be a storage device 103, a graphic processing device 104, an input interface 105, an optical driving device 106, a device coupling interface 107, and a network interface 108.

The storage device 103 writes and reads data electrically or magnetically in and from a recording medium mounted therein. The storage device 103 is used as an auxillary storage device of the computer. The storage device 103 stores programs, application programs, and various pieces of data of the OS. An HDD or a solid-state drive (SSD) may be used as the storage device 103, for example.

The graphic processing device 104 is coupled to a monitor 21. In response to an instruction from the processor 101, the graphic processing device 104 displays an image on a screen of the monitor 21. The monitor 21 may be a display device using organic electro luminescence (EL), a liquid crystal display device, or the like.

The input interface 105 is coupled to a keyboard 22 and a mouse 23. The input interface 105 transmits signals transmitted from the keyboard 22 and the mouse 23 to the processor 101. The mouse 23 is an example of a pointing device, and another pointing device may be used as the mouse 23. The other pointing device may be a touch panel, a tablet, a touch pad, a trackball, and so on.

The optical driving device 106 reads data recorded in an optical disc 24 by using laser light and the like. The optical disc 24 is a portable recording medium in which data readable by light reflection is recorded. The optical disc 24 may be a digital versatile disc (DVD), a DVD-RAM, a compact disc read-only memory (CD-ROM), a CD-recordable/rewritable (CD-R/RW), and so on.

The device coupling interface 107 is a communication interface that couples the peripherals to the optimizer 100. For example, the device coupling interface 107 may couple a memory device 25 and a memory reader/writer 26. The memory device 25 is a recording medium with a function of communicating with the device coupling interface 107. The memory reader/writer 26 is a device that writes data in a memory card 27 or reads data from the memory card 27. The memory card 27 is a card-type recording medium.

The network interface 108 is coupled to a network 20. The network interface 108 transmits and receives data to and from another computer or a communication device through the network 20.

With the above-described hardware configuration, the optimizer 100 is able to implement processing functions of the second embodiment. The optimizer 10 described in the first embodiment may also be implemented by hardware like that of the optimizer 100 illustrated in FIG. 2.

The optimizer 100 implements the processing functions of the second embodiment by, for example, executing the program recorded in a computer-readable recording medium. The program in which details of the processing to be executed by the optimizer 100 are written may be recorded in various recording media. For example, the program to be executed by the optimizer 100 may be stored in the storage device 103. The processor 101 loads at least a part of the program in the storage device 103 to the memory 102 and executes the program. The program to be executed by the optimizer 100 may be recorded in a portable recording medium such as the optical disc 24, the memory device 25, and the memory card 27. The program stored in the portable recording medium is able to be executed after being installed in the storage device 103 by the control by the processor 101, for example. The processor 101 may read the program directly from the portable recording medium to execute the program.

It is possible to obtain the global minimum of the Ising energy functions and the combination of the state variables from which the global minimum is obtained by using the optimizer 100 with the above-described hardware. The energy functions as the solution target may be expressed by the Hamiltonian.

The Ising energy function (H({x})) is defined by the following Expression (1), for example.

$$H ( \{ x \} ) = - {\sum }_{i = 1}^{N} {\sum }_{j > i}^{N} {W}_{ij} {x}_{i} {x}_{j} - {\sum }_{i = 1}^{N} {b}_{i} {x}_{i} - C \qquad ( 1 )$$

The first term on the right-hand side is integration of products of values (0 or 1) of two state variables and weight coefficients of all the combinations of N state variables, the integration being performed completely with no overlapping. xᵢ represents an i-th state variable, xⱼ represents a j-th state variable, and Wᵢⱼ is a weight coefficient representing a magnitude of the interaction of xᵢ and xⱼ. The second term on the right-hand side is a summation of the products of bias coefficients be of the respective state variables and the values of the corresponding state variables, and the third term C on the right-hand side is a constant.

The optimizer 100 obtains the global minimum of the energy functions (H({x})) of the N state variables. For example, the optimizer 100 executes the Markov chain Monte Carlo computation under the Boltzmann distribution as a statistics distribution. The reason why the Boltzmann distribution is used for the computation is because the Ising model is a model originally contrived to simulate the physical properties of a magnetic substance. During the simulation, the optimizer 100 performs the actual computation as described below.

First, the optimizer 100 uses a pseudo random number generator to randomly select a state variable xᵢ to be inverted. After the selecting, the optimizer 100 computes an energy difference ΔE. When the selected state variable is represented by xₖ, the variation of the value of the energy function (energy difference (E)) according to the variation of the value of the state variable xₖ is expressed by the following Expression (2).

ΔE=−(1−2xₖ)hₖ (2)

“1-2xₖ” of Expression (2) represents an amount of variation of xₖ (Δxₖ). When xₖ is varied from 1 to 0, 1-2xₖ=−1, and when xₖ is varied from 0 to 1, 1-2xₖ=1. hₖ is called a local field and is expressed by the following Expression (3).

$${h}_{k} = {\sum }_{i = 1 , i \neq k}^{N} {W}_{ki} {x}_{i} + {b}_{k} \qquad ( 3 )$$

The energy difference DE is obtained by Expression (2) and Expression (3), and thus the optimizer 100 determines whether to accept the new state in which the selected state variable xₖ is varied. For example, the optimizer 100 determines whether to accept the new state by using the transition probability in the form of Expression (4) according to the Metropolis method.

$${P}_{i \to j} = min ( 1 , \frac{{π}_{j} ( \{ x \} )}{{π}_{i} ( \{ x \} )} ) = min ( 1 , exp ( - β Δ E ) ) \qquad ( 4 )$$

In Expression (4), nᵢ({x}) is a probability distribution indicating the probability with which a state defined by {x} (representing a value of each state variable) is implemented. P_{i→j} represents a transition probability of a transition from the state i to the state j. β represents an inverse temperature (an inverse of a value of the temperature parameter).

The optimizer 100 repeats the probabilistic state transition as described above. In this way, the thermal equilibrium state at the given temperature is achieved. For example, it is possible to obtain the energy global minimum with the processing unit 12 executing the simulation while sufficiently decreasing the temperature.

In the SA method, the temperature T is decreased to be closer to 0 with the advancing of the simulation. The transition in a direction in which the energy is increased is inhibited as the temperature T is decreased to be closer to 0, and thus a stationary point of the energy of Expression (1) is obtained. This is a stationary point and is not necessarily the global minimum. For this reason, the SA method employs a strategy that an optimum solution is obtained heuristically by performing trials multiple times with different initial conditions.

When Expression (1) is solved numerically by the Metropolis method using the Boltzmann distribution, there are the following obstructive factors for obtaining the optimum solution.

[Obstructive Factor 1] There are numberless local optimum solutions of the energy functions, and the solutions are trapped easily and not able to escape. Consequently, the solution to be obtained is far different from a solution desired to be obtained.

[Obstructive Factor 2] In the Boltzmann distribution, it is considerably difficult to escape from the energy trap with the simulation within realistic time. Consequently, significant amount of computation sources and computation time are consumed.

[Obstructive Factor 3] Although it is possible to improve the sampling efficiency by using the expanded ensemble method such as the replica exchange method, it is difficult to allow the random walk in the temperature space.

Because of the above-described obstructive factors, it is difficult to reach the optimum solution by executing the simulation of Expression (1) in a normal way. To deal with this, there is a method for overcoming those difficulties, and the replica exchange method is a representative example. If the replica exchange method is adopted, the optimizer 100 optimizes all the replicas while exchanging the replicas executing simulations of different temperatures. Thus, the computation amount is increased according to the number of the replicas prepared. It is important for efficient sampling that all the replicas are moved around widely from the low temperature region to the high temperature region, and when the degrees of freedom of a corollary are increased, the number of the replicas is increased at an accelerated pace. If a phase transition occurs in the corollary, there is a tendency that the efficient replica exchange is disturbed at the phase transition point, and the replicas are divided into the low temperature region and the high temperature region. The phase transition occurs less if the number of the replicas is increased; however, the computation amount is increased, and a parallel computation device has to be used as the optimizer 100.

Therefore, the optimizer 100 in the second embodiment provides the replicas with proper temperature setting to inhibit the occurrence of the phase transition even when the number of the replicas is small and to enable the replicas to perform the random walk in the temperature space.

Next, the replica exchange method is described in detail. First, the configuration of the energy function as the solution target is simply described. The practicable problem is multidimensional, and the energy function to be obtained includes many local minima. A drawing illustrating the variation of the value of the energy function according to the state variables is called an energy landscape.

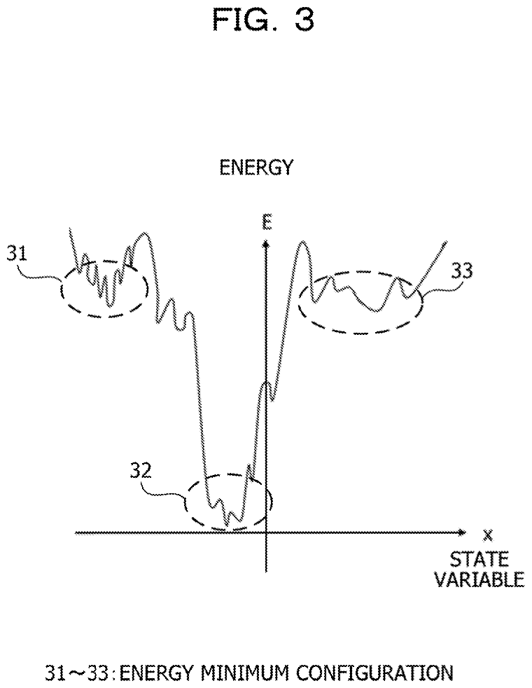

FIG. 3 is a diagram illustrating an example of the energy landscape. In FIG. 3, the horizontal axis represents a value of the state variable, and the vertical axis represents a value of the energy. The difficulty of the energy global minimum problem in the multidimensional space is the comprehensive minimum configuration of the energy function. For example, in FIG. 3, there are three comprehensive energy minimum configurations 31 to 33 in a comprehensive view. There are small numberless energy barriers (rising of the energy in the transition between adjacent local minima) within and around each of the energy minimum configurations 31 to 33. In some cases, when the set temperature of the replica is improper, the energy global minimum is obtained within the energy minimum configurations 31 and 33 based on the initial value, and the energy global minimum actually desired to be obtained within the energy minimum configuration 32 may not be obtained. This is because the energy barriers between the energy minimum configurations 31 to 33 are large.

The replica exchange method is a method developed to solve the above problem.

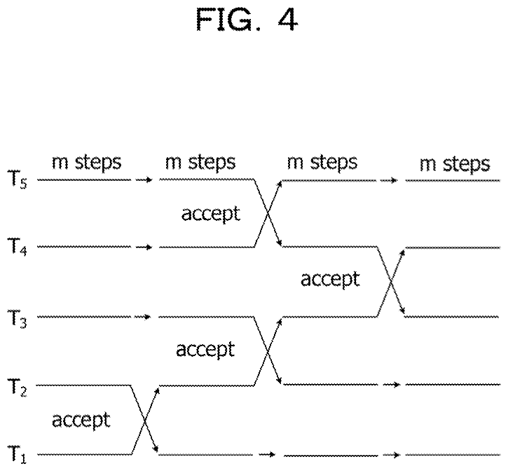

FIG. 4 is a diagram illustrating an overview of the replica exchange method. In the replica exchange method, the optimizer 100 prepares M temperature rows {T₀, T₁, . . . , T_{M}} (M is an integer of 2 or greater) from the high temperature region to the low temperature region. The optimizer 100 generates M solution targets (pairs of the state variables) and performs simulations independently at different temperatures in each of the temperature rows while advancing the temporal steps. The optimizer 100 then exchanges the temperatures between the solution targets to satisfy the principle of detailed balance. In this way, each simulation box (simulation for each solution target) is able to perform the random walk in the temperature space while satisfying the principle of detailed balance as a whole. It is thus possible to pass through the high temperature region and exceed the high energy barriers.

Each simulation box is called a replica, and such a simulation method is called the replica exchange method because the temperatures set for two replicas are exchanged based on a certain standard. The exchanging of the temperatures between the replicas is called the replica exchange.

The replica exchange method is a method making achievements in the magnetic substance field, the folding problem of protein, and the like. On the other hand, there are also disadvantages. Hereinafter, the disadvantages of the replica exchange method are simply described.

Here are two replicas of i-th and j-th considered. In this case, combinations of the inverse temperature and a coordinate (value of the state variable) are represented by (βᵢ, {x}ᵢ) and βⱼ, {x}ⱼ). The probability distributions to which the corresponding replica particles are according to are represented by nβᵢ, {x}ᵢ) and n(βⱼ, {x}ⱼ). States before and after the replica exchange occurs in the two state corollaries are A and B, which are defined as follows.

[state A] i-th replica is {Xᵢ}, βᵢ), and j-th replica is ({Xⱼ}, βⱼ)

[state B] i-th replica is ({Xⱼ}, βᵢ), and j-th replica is ({Xᵢ}, βⱼ)

In the thermal equilibrium state, the respective probability distributions P_{A}(t) and P_{B}(t) of the state A and the state B are expressed by the product of the probabilities of an independent event. For example, the probability distributions P_{A}(t) and P_{B}(t) are expressed by the following Expression (5) and Expression (6).

P_{A}(t)=π(βᵢ,{xᵢ})π(βⱼ,{xⱼ}) (5)

P_{B}(t)=π(βᵢ,{xⱼ})π(βⱼ,{xᵢ}) (6)

Accordingly, a transition probability P_{A→B} from the state A to the state B may be written as the following Expression (7).

$${P}_{A \to B} = min \{ 1 , \frac{{P}_{B} ( t )}{{P}_{A} ( t )} \} = min \{ 1 , \frac{π ( {β}_{i} , \{ {x}_{j} \} ) π ( {β}_{j} , \{ {x}_{i} \} )}{π ( {β}_{i} , \{ {x}_{i} \} ) π ( {β}_{j} , \{ {x}_{j} \} )} \} \qquad ( 7 )$$

min{ } is an operator indicating to pick up the global minimum of the elements in the parentheses. When the formula of the Boltzmann distribution is substituted into Expression (7), the following Expressions (8) are obtained.

$${P}_{A \to B} = min \{ 1 , \frac{{P}_{B} ( t )}{{P}_{A} ( t )} \} = min \{ 1 , exp ( Δ β \cdot Δ E ) \} \qquad ( 8 )$$

Δβ=βⱼ−βᵢ (9)

ΔE=Eⱼ−Eᵢ (10)

Eᵢ and Eⱼ in Expression (10) are the energies of the i-th replica and the j-th replica, respectively. The energy of each replica is obtained by substituting the state variable at the moment into Expression (1).

In the replica exchange method, the detailed balance for the exchange between the replicas is made, and the detailed balance for each replica is also made. The replica exchange may be executed every steps or may be executed every arbitrary number of steps. The sampling efficiency is varied depending on the frequency of the replica exchange.

The replica exchange method as described above has disadvantages. The first disadvantage is the large computation amount. When the M replicas are prepared for the execution of the computation, the computation amount grows M times. When the degrees of freedom of the problem are increased, the number of the replicas used for the computation is also increased. Usually, the computation time is compressed by the parallel computation to deal with this; however, instead, the number of the computation devices to be used grows M times.

The second disadvantage is that it is difficult to perform the random walk in the temperature space.

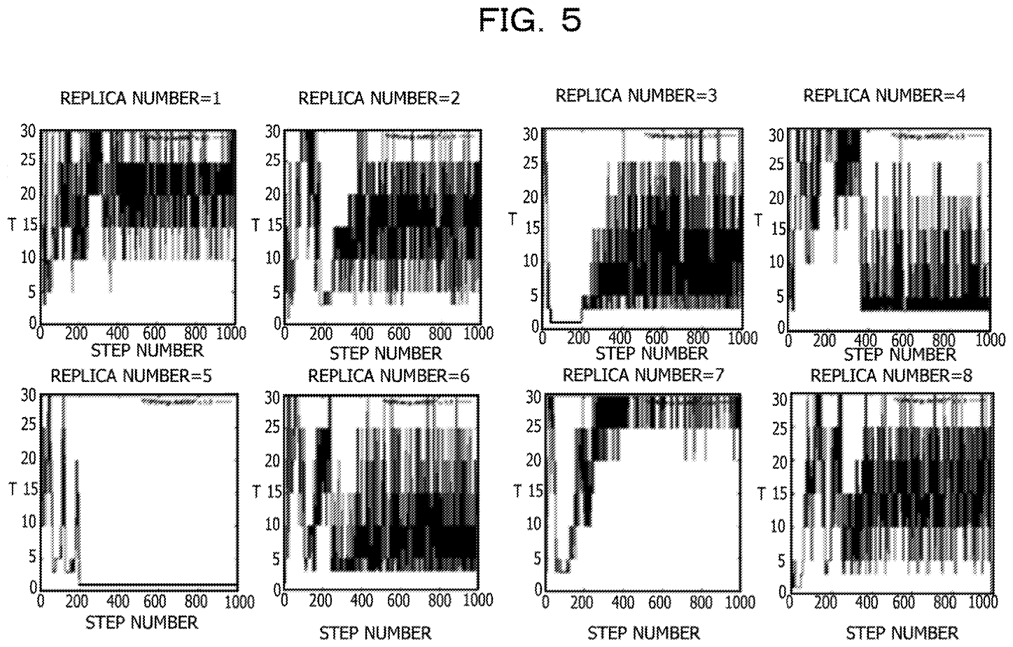

FIG. 5 is a diagram illustrating an example of temperature transitions of replicas in the replica exchange method. FIG. 5 illustrates the transition of the temperatures (T) according to the advancing of the temporal steps in each of eight replicas of replica numbers=1 to 8. The horizontal axis represents the number of steps, and the vertical axis represents T (positive real number). As illustrated in FIG. 5, it may be seen that it is hard to say that the replicas perform the random walk in the temperature space with equal probability. For example, the replica of the replica number=1 hardly transits to a region in which the temperature is 10 or lower. The replica of the replica number=5 is fixed at T=1.0 from where the number of steps is around 200. Thus, it is difficult to perform the random walk in the temperature space in the replica exchange method.

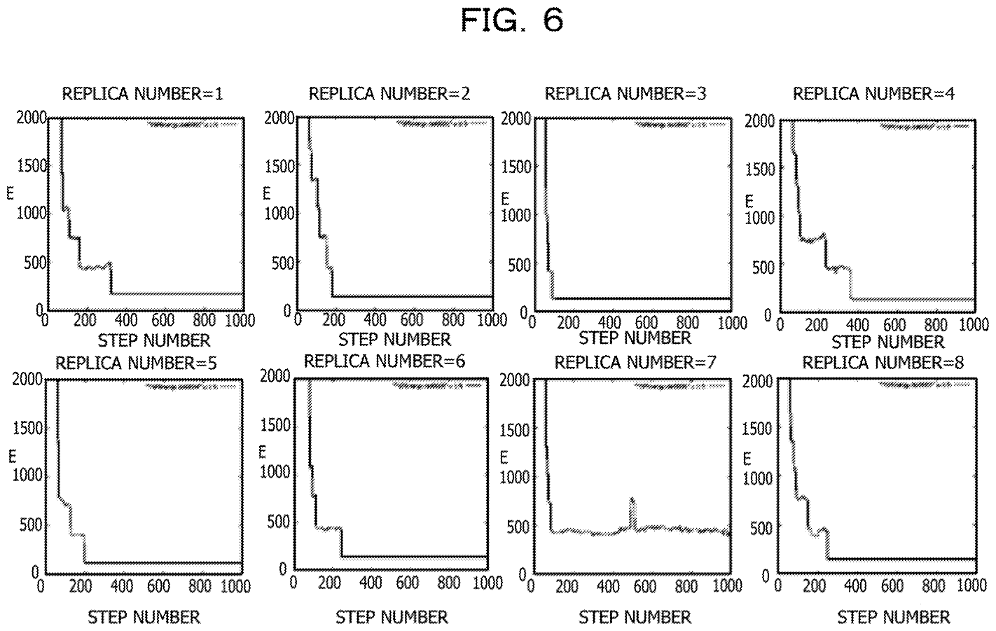

FIG. 6 is a diagram illustrating an example of computation results of the energies in the replica exchange method. FIG. 6 illustrates a computation result of an energy (E) in each of the eight replicas of the replica numbers=1 to 8. The horizontal axis represents the number of steps, and the vertical axis represents the energy (E).

As illustrated in FIG. 6, it may be seen that the energies of almost all the replicas are trapped by the local minima and not able to escape. For example, when the random walk is unable to be performed, the energy of the replica is unable to reach values of lower energies including the global minimum.

Hereinafter, a temperature optimization method of the replica exchange is described in detail.

First, the reason why the best sampling efficiency is acquired by optimizing the temperatures of the replicas in the replica exchange method is described. In the replica exchange method, the replica best sampling efficiency is not obtained even if the temperatures are set at regular intervals. This is because the exchange probability is an exponential attenuation of the product of the energy difference and the inverse temperature difference. Thus, when the temperatures of the replicas are set at regular intervals, the replicas are divided into the high temperature layer and the low temperature layer, and the replicas are unable to exceed the energy barriers in the high temperature region. Consequently, the sampling space is not expanded as illustrated in FIG. 6. Thus, when the temperatures of the replicas are improper, proper random walks do not occur. As a result, the sampling space in the simulation using the replica exchange method is not expanded. This problem is not acknowledged as a problem when the number of the state variables as the solution target is small, but it becomes a severe problem once the degrees of freedom are increased.

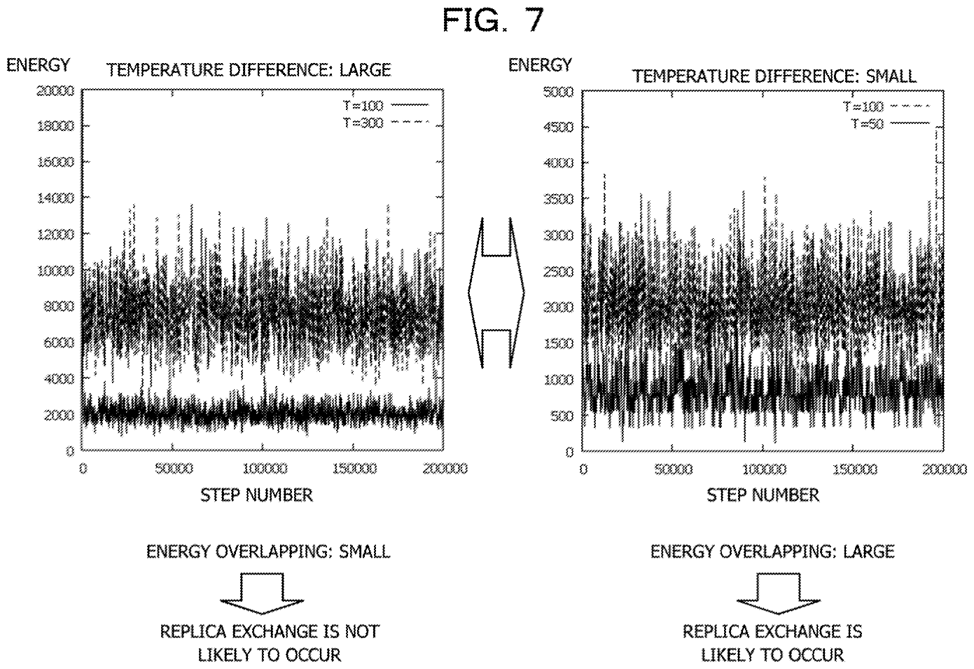

Next the relationship between the temperature difference and the replica exchange probability between the replicas is described with reference to FIG. 7.

FIG. 7 is a diagram illustrating an example of temporal variations of energies of two replicas of different temperatures. In the example of FIG. 7, the computation simulation of the energy function is repeatedly executed on each of the replicas under the same initial conditions except the temperatures. With the computation repeated, each replica becomes the thermal equilibrium state, and the energy value is varied within a certain range. In FIG. 7, the horizontal axis represents the number of steps, and the vertical axis represents the energy (E).

A left diagram of FIG. 7 is temporal variations of energies of a replica of T=100 (lower polygonal line) and a replica of T=300 (higher polygonal line). In this example, overlapping of the energies hardly occurs since the temperature difference between the replicas is large. Consequently, the replica exchange itself does not occur.

A right diagram of FIG. 7 is temporal variations of energies of a replica of T=50 (lower polygonal line) and the replica of T=100 (higher polygonal line). In this example, the energies overlap with each other since the temperature difference between the replicas is small. The replica exchange is likely to occur when the energies overlap with each other.

Thus, if the temperature difference between the replicas is made small, the replica exchange is likely to occur. When the temperature differences between the adjacent replicas when all the replicas are arranged in the order of temperature are all small, each replica easily performs the random walk properly in the entire temperature space. When the temperature differences between the replicas in the entire temperature space are made small, the number of the replicas is increased. This causes a remarkable increase in the processing amount described as the first disadvantage of the replica exchange method.

In view of this, the optimizer 100 achieves the optimization of the temperatures of the replicas to inhibit the increase in the number of the replicas and to facilitate the occurrence of the replica exchange, and the random walk of each replica is implemented. For example, the optimizer 100 determines the temperature of each replica so as to achieve temperature differences that allow proper overlapping of the energies between the replicas of adjacent temperatures.

For example, as illustrated in the left diagram of FIG. 7, the replica of T=100 and the replica of T=300 have different amplitudes of energies along with the temporal variation. When the temperature range has large amplitudes of energies, the energies overlap with each other even if the temperature differences between the replicas are increased, and the replica exchange is likely to occur. On the other hand, in the temperature range having small amplitudes of energies, the energies do not overlap with each other when the temperature differences between the replicas are large. For this reason, the optimizer 100 properly sets the temperature differences between the replicas in each temperature range. Consequently, the replica exchange is likely to occur over the entire temperature space while inhibiting the increase in the number of the replicas.

Next, the temperature optimization method for providing the best sampling efficiency is described in detail. In the following method, the specific heats are assumed to be continuous functions. Accordingly, a case of a phase transition in which the specific heats are not continuous is not targeted. This is because the number of particles in the corollary in which the simulation is executed is normally finite, and the specificity by the phase transition occurs at the limit of the infinity of the number of particles.

The case in which the best sampling efficiency is implemented in the replica exchange method is a case in which all the replicas perform the random walks high and low in the temperature space. Such a random walk is called a proper random walk.

As long as the occurrence probabilities of the replica exchange between the adjacent replicas when the replicas are arranged in the order of temperature are all equal probabilities, the proper random walk is implemented. Therefore, as long as all the replicas of Expression (8) satisfy the following Expression (11), the proper random walk is implemented.

Δ₀=(βᵢ−βⱼ)(E(Xⱼ)−E(Xᵢ))=−Δβ·ΔE=const. (11)

Δ₀ represents a replica exchange probability coefficient. In this case, when j=i+1, Expression (12) is obtained where Tⱼ=Tᵢ₊₁=Tᵢ+ΔTᵢ.

$${β}_{i} - {β}_{j} = \frac{1}{{k}_{B}} ( \frac{1}{{T}_{i}} - \frac{1}{{T}_{i} + Δ {T}_{i}} ) ≅ \frac{1}{{k}_{B}} \frac{Δ {T}_{i}}{{T}_{i}^{2}} \qquad ( 12 )$$

ΔE may be expressed as Expression (13).

ΔE=E(Xⱼ)−E(Xᵢ) (13)

In this case, the replica exchange probability coefficient Δ₀ is deformed as below.

$${Δ}_{0} = \frac{1}{{k}_{B}} \frac{Δ {T}_{i}}{{T}_{i}^{2}} Δ E = \frac{1}{{k}_{B}} \frac{{( Δ {T}_{i} )}^{2}}{{T}_{i}^{2}} \frac{Δ E}{Δ {T}_{i}} \qquad ( 14 )$$

In this case, if a case in which the energy difference is not varied greatly with respect to the temperature difference or a case in which there are many replicas is considered, the following Expression (15) is satisfied.

$$\frac{Δ E}{Δ {T}_{i}} ≅ {( \frac{\partial E}{\partial T} )}_{{T}_{i}} \qquad ( 15 )$$

When Expression (15) is applied to Expression (14), Expression (14) becomes the following Expression (16).

$${Δ}_{0} = \frac{1}{{k}_{B}} \frac{{( Δ {T}_{i} )}^{2}}{{T}_{i}^{2}} {( \frac{\partial E}{\partial T} )}_{{T}_{i}} \qquad ( 16 )$$

When Expression (16) is used to solve ΔTᵢ, the following Expression (17) is obtained.

$$Δ {T}_{i} = {T}_{i} \sqrt{\frac{{k}_{B} {Δ}_{0}}{{( \frac{\partial E}{\partial T} )}_{{T}_{i}}}} = {T}_{i} \sqrt{\frac{{k}_{B} {Δ}_{0}}{{C}_{V} ( T )}} \qquad ( 17 )$$

In this case, C_{V} is an amount called a specific heat at constant volume. In the following descriptions, the specific heat at constant volume C_{V} is simply referred to as a specific heat in some cases. ΔTᵢ may also be expressed by the following Expression (18).

ΔTᵢ=Tᵢ₊₁−Tᵢ (18)

A next temperature Tᵢ₊₁ that evens out the replica exchange probabilities from the given temperature Tᵢ is given by the following Expression (19) and Expression (20).

$$\begin{matrix}{T}_{i + 1} = {T}_{i} + Δ {T}_{i} = γ ( {T}_{i} ) {T}_{i} & ( 19 ) \\ γ ( T ) = 1 + \sqrt{\frac{{k}_{B} {Δ}_{0}}{{C}_{V} ( T )}} & ( 20 )\end{matrix}$$

For example, the temperature Tᵢ₊₁ an i+1-th replica is defined by normally multiplying a reference temperature by a proportionality coefficient. Next, boundary conditions are given for the behavior of the specific heat. The specific heat satisfies the following boundary conditions.

$$\begin{matrix}{lim}_{T \to 0} {C}_{V} ( T ) = 0 & ( 21 ) \\ {lim}_{T \to ∞} {C}_{V} ( T ) = 0 & ( 22 )\end{matrix}$$

Expression (21) is a request based on the third law of thermodynamics. Accordingly, the behavior of a temperature interval coefficient γ(T) satisfies the following boundary conditions.

$$\begin{matrix}{lim}_{T \to 0} γ ( T ) = ∞ & ( 23 ) \\ {lim}_{T \to ∞} γ ( T ) = ∞ & ( 24 )\end{matrix}$$

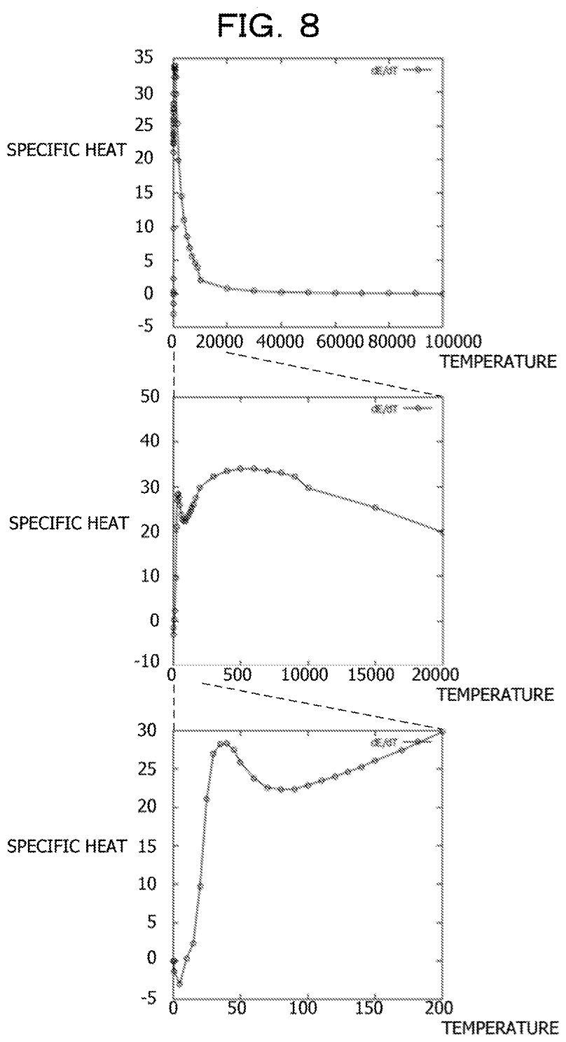

When the specific heat C_{V}(T) is computed for a specific problem, the situation as illustrated in FIG. 8 is given, for example.

FIG. 8 is a diagram illustrating an example of temperature variations of the specific heats. The upper drawing of FIG. 8 illustrates a temperature variation of the specific heat of a range of temperature from 0 to 100000K. The middle drawing of FIG. 8 illustrates a temperature variation of the specific heat of a range of temperature from 0 to 20000K. The lower drawing of FIG. 8 illustrates a temperature variation of the specific heat of a range of temperature from 0 to 200K. In each graph illustrated in FIG. 8, the horizontal axis represents a temperature, and the vertical axis represents a specific heat.

According to the temperature variations of the specific heats of FIG. 8, it may be seen that the boundary conditions of the specific heats expressed by Expression (21) and Expression (22) are satisfied. It may also be seen that the specific heats each have a configuration of including two local minima and two local maxima.

With reference to FIG. 8, the reason why the replicas are divided into the high-temperature phase and the low-temperature phase during the replica exchange like FIG. 5 may be seen. As illustrated in FIG. 8, since the specific heats have the local maxima, the specific heats are increased according to the increase in temperature in the temperature range in which the temperature T set as the absolute temperature is 20K<T<40K, and the increasing tendency is also rapid.

In this temperature range in which the specific heat is rapidly increased, the energy difference generated by the temperature difference between the replicas is also rapidly increased. For this reason, when the temperatures to be set for the replicas are set at regular intervals in the temperature range in which the specific heats are increased rapidly, the replica exchange probability coefficient Δ₀ of Expression (11) becomes a large value that affects the replica exchange probability in the temperature range with the excessive energy differences. Consequently, in the temperature range in which the specific heats are increased and the energy differences are excessive, almost all the trials of performing the replica exchange are dismissed. On the other hand, the replica exchange is performed in a temperature range out of the region in which the specific heats are increased rapidly and that has small specific heats and small energy differences.

As a result, the temperature range in which the replica exchange occurs is substantially divided at the temperature at which the specific heat becomes the local maximum point, and the replicas are divided into the high-temperature phase and the low-temperature phase. It may also be seen that the replica exchange in a direction of increasing temperature and the replica exchange in a direction of decreasing temperature have to occur with the equal probability. This is because the probability current is no more in a steady state if the replica exchange is likely to occur only in one direction (direction of decreasing temperature or increasing temperature). For example, the local maximum point of the specific heat serves as a reflection wall for the probability current of the replica exchange.

In order to solve the above problem, the optimizer 100 reduces temperature interval widths to be set for the replicas in the temperature range of the specific heats increased rapidly with the temperature set 20K<T<40K in FIG. 8, for example. On the other hand, the optimizer 100 increases the temperature interval widths to be set for the replicas in the temperature range of small specific heats. In this way, the optimizer 100 allows the replica exchanges to occur with the equal probability in both the temperature decreasing direction and the temperature increasing direction, and it is possible to maintain the current of the probability fixed.

For example, the optimizer 100 sets the temperature of each replica in the replica exchange so as to satisfy the condition where the replica exchange probability coefficient Δ₀ is fixed between the adjacent replicas when the replicas are arranged in the order of the set temperatures. The expression for determining the intervals of temperature to satisfy this condition is Expression (20).

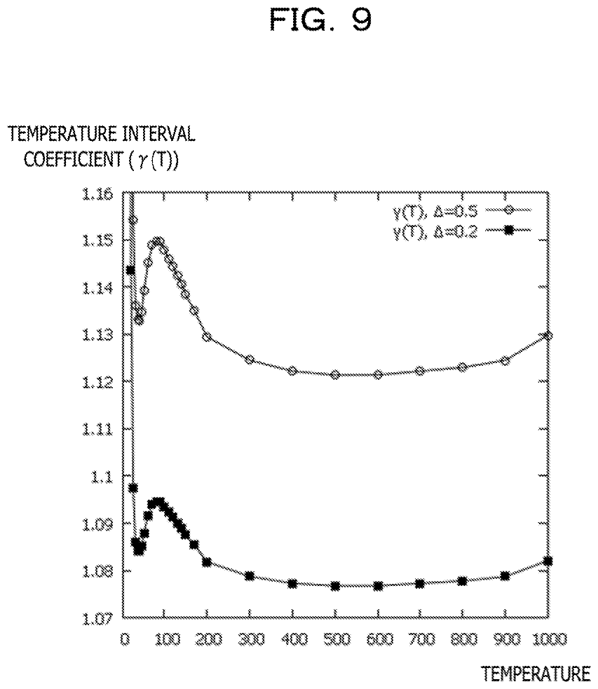

FIG. 9 is a diagram illustrating a relationship between the temperature interval coefficient and the temperature of a replica. In FIG. 9, the horizontal axis represents a temperature, and the vertical axis represents the temperature interval coefficient γ(T). FIG. 9 illustrates cases where the replica exchange probability coefficient Δ₀, which is a parameter of relating the temperature interval coefficient γ(T) with the replica exchange probability, is “0.2” (polygonal line coupling the black rectangles) and is “0.5” (polygonal line coupling the white circles).

According to FIG. 9, the temperature interval coefficients are decreased in the region in which the specific heats are varied rapidly, and it may be seen that it is proper to decrease the temperature interval widths. On the other hand, in the high temperature region, it is possible to assume that the temperature interval coefficients are substantially fixed. Thus, it may be seen that the replica temperatures may be set at regular intervals in the high temperature region.

The dependency of the temperature interval widths on the values of the replica exchange probability coefficients Δ₀ is also not ignorable. The replica exchange probability coefficients Δ₀ are values set for the optimizer 100 depending on the computation amount and accuracy of the simulation by a user who instructs the simulation by the replica exchange method.

Once the replica exchange probability coefficient h is increased, the replica exchange probability is decreased based on Expression (8) and Expression (11). If the low replica exchange probability is allowable, it is possible to make the temperature interval width large. In this case, although the replica exchange probability is decreased, the computation amount heads to be reduced since the number of the replicas is decreased. On the other hand, if the replica exchange probability is desired to be increased, the user may decrease the replica exchange probability coefficient Δ₀. In this case, although the temperature interval width is small, the replica exchange probability is increased. The number of the replicas is then increased, and the computation amount heads to be increased.

In order to implement the best optimization of the sampling efficiency, it is proper to increase the replica exchange probability but not increase the number of the replicas and obtain the optimum value determined by the tradeoff of both the exchange probability and the number of the replicas. However, since the optimum value depends on the problem, the user has to make the determination properly depending on the problem.

Next, functions of the optimizer 100 for obtaining a solution by the replica exchange method are described.

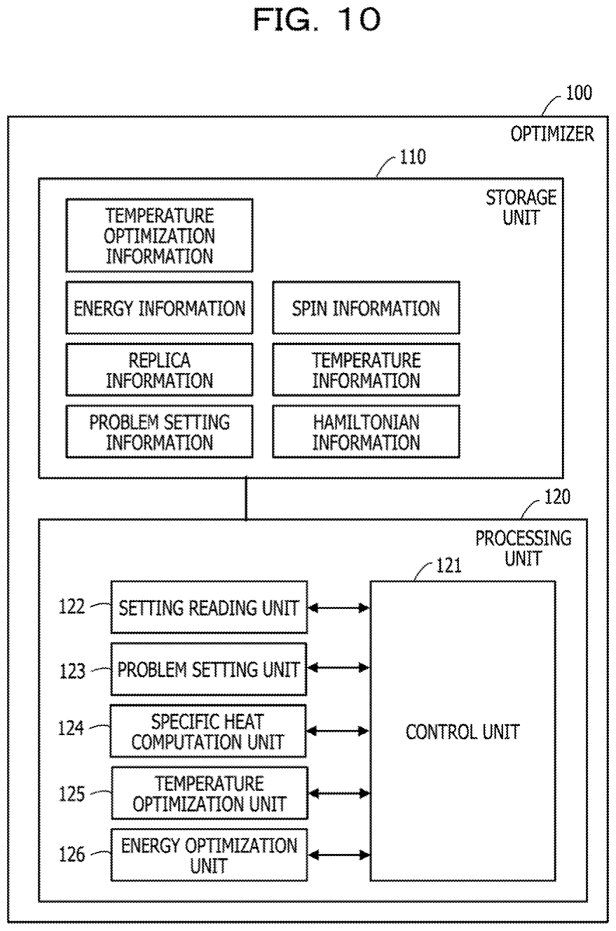

FIG. 10 is a block diagram illustrating the functions of the optimizer. The optimizer 100 includes a storage unit 110 and a processing unit 120. The storage unit 110 is implemented by a part of a storage region of the memory 102 or the storage device 103, for example. The processing unit 120 is implemented by causing the processor 101 to execute a predetermined program, for example.

The storage unit 110 stores temperature optimization information, energy information, spin information, replica information, temperature information, problem setting information, and Hamiltonian information.

The temperature optimization information is information used for the optimization of the set temperature of the replicas. For example, the temperature optimization information includes the replica exchange probability coefficient Δ₀, preliminary computation step number N, specific heat computation temperature rows, the global minimum T₁′ of the temperature rows to be optimized, and the like. The replica exchange probability coefficient Δ₀ is a coefficient that determines the probability of the replica exchange and is a constant that satisfies Expression (11). The preliminary computation step number N is the number of steps of temporal advancement of the simulation when computing the energy computation of the replica at a temperature at which the specific heat is computed (specimen temperature for the specific heat computation). The specific heat computation temperature rows are an array of the M temperature values (M is an integer of 1 or greater) for the specific heat computation. The specific heat computation temperature rows are an example of the multiple sample temperature values of the first embodiment. The global minimum T₁′ of the temperature rows to be optimized is the global minimum of the temperatures to be set for the replicas.

The energy information includes a predetermined number of energy values in ascending order from the global minimum out of the computed initial value of the energy and the energy values computed so far. The energy information may include combinations of values of the state variables corresponding to the predetermined number of the energy values. The spin information includes the values of the state variables. The replica information is information used to execute the replica exchange method and includes the number of the replicas and the like. The temperature information includes a value of the temperature parameter (hereinafter, simply referred to as a temperature) or the inverse temperature. The problem setting information includes, for example, an optimization method to be used (SA method, replica exchange method, and so on), the frequency of the replica exchange and annealing, the sampling frequency, a temperature variation schedule, information on the transition probability distribution to be used, the number of times of computation of the MCMC computation as a computation termination condition, and the like. The Hamiltonian information includes, for example, the weight coefficient Wᵢⱼ, the bias coefficient bᵢ, the constant C, and so on of the energy function expressed by Expression (1).

The processing unit 120 includes a control unit 121, a setting reading unit 122, a problem setting unit 123, a specific heat computation unit 124, a temperature optimization unit 125, and an energy optimization unit 126.

The control unit 121 controls the units of the processing unit 120 and performs the global minimum obtaining processing.

The setting reading unit 122 reads various types of information described above from the storage unit 110 in the form understandable by the control unit 121.

The problem setting unit 123 computes the initial value of the state variable and the initial value of the global minimum of the energy.

The specific heat computation unit 124 computes the specific heats at multiple temperatures for the solution problem.

The temperature optimization unit 125 performs the optimization of the temperatures set for the replicas based on the specific heats according to the temperatures.

The energy optimization unit 126 sets the optimized temperatures for the replicas, executes the simulation by the replica exchange method, and obtains the global minimum of the energies.

The lines coupling the elements illustrated in FIG. 10 indicate a part of a communication path, and a communication path other than that illustrated in FIG. 10 may be set. The functions of the elements illustrated in FIG. 10 may be implemented by causing the computer to execute program modules corresponding to the elements, for example.

Next, the computation method of the specific heat by the specific heat computation unit 124 is described in detail. The specific heat may be computed as a function of the temperature. Thus, the specific heat computation unit 124 solves Expression (1) by the Metropolis-Hastings algorithm based on discrete temperature rows (temperature Tⱼ (j=1, 2, . . . , M)). The specific heat computation unit 124 also computes an average value <Eⱼ> and a squared average value <E²> of the energies based on the obtained energy rows. Since the distribution is the Boltzmann distribution, the specific heat computation unit 124 then computes the specific heat by the following Expression (25).

$${C}_{v} ( {T}_{j} ) = \frac{〈 {E}^{2} 〉 - {〈 E 〉}^{2}}{{T}_{j}^{2}} \qquad ( 25 )$$

As described above, the specific heat computation unit 124 performs the simulation as the preliminary computation at each temperature Tⱼ in a short period of time and computes the specific heat, and the specific heat for each temperature is obtained as illustrated in FIG. 8.

The above is the computation method of the specific heat. Next, the optimization method of the temperatures by the temperature optimization unit 125 is described.

When the specific heat is obtained numerically, the temperature optimization unit 125 computes the temperature interval width ΔTᵢ by using Expression (17). In this case, in order to make the computation by Expression (17) with a temperature other than the temperature row (temperature Tⱼ (j=1, 2, . . . , M)) specified at the preliminary computation, the temperature optimization unit 125 uses the interpolation method and the like to expand the specific heat to a continuous variable according to the temperature. In a simple example, the temperature optimization unit 125 is able to use the linear interpolation. For example, when the temperature T₀ satisfies Tⱼ<T₀<Tⱼ₊₁, the temperature optimization unit 125 computes the temperature interval coefficient γ(T) by the following Expression (26) for the linear interpolation, for example.

$$γ ( T ) = \frac{γ ( {T}_{j + 1} ) - γ ( {T}_{j} )}{{T}_{j + 1} - {T}_{j}} ( T - {T}_{j} ) + γ ( {T}_{j} ) \qquad ( 26 )$$

Although Expression (26) is an example of the linear interpolation, a higher interpolation method may be used by using a function that continuously and smoothly interpolates differentials as well.

Next, procedures of the energy global minimum obtainment processing are described in detail.

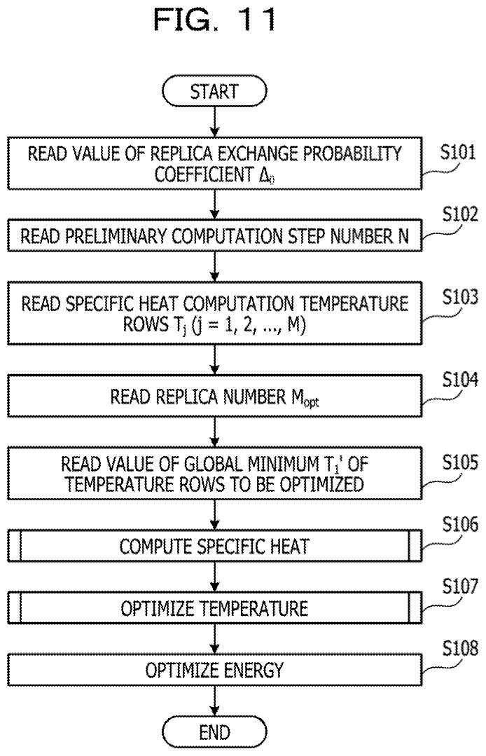

FIG. 11 is a flowchart illustrating an example of the procedures of the energy global minimum obtainment processing. Hereinafter, the processing illustrated in FIG. 11 is described along the step numbers.

[step S101] The setting reading unit 122 reads the replica exchange probability coefficient Δ₀ from the storage unit 110. The replica exchange probability coefficient Δ₀ is a value inputted by the user in advance.

The greater the value of the replica exchange probability coefficient Δ₀, the greater the width of temperature interval and the smaller the number of the replicas. On the other hand, the smaller the value of the replica exchange probability coefficient Δ₀, the smaller the width of temperature interval and the greater the number of the replicas. When the value of the replica exchange probability coefficient Δ₀ is too large, the temperature interval becomes too rough; for this reason, the user sets the replica exchange probability coefficient Δ₀ of a proper value to obtain the proper number of the replicas. For example, the user sets Δ₀=1.0. The setting reading unit 122 transmits the read replica exchange probability coefficient Δ₀ to the control unit 121.

[step S102] The setting reading unit 122 reads the preliminary computation step number N from the storage unit 110. The preliminary computation step number N is a value inputted by the user in advance.

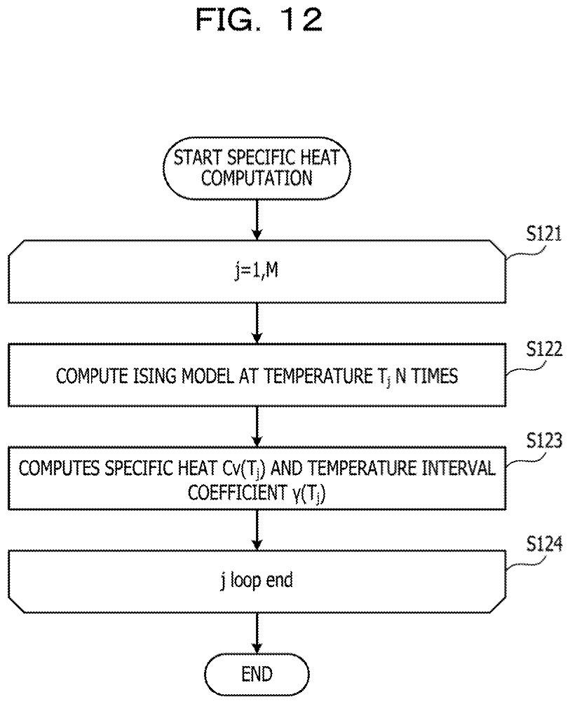

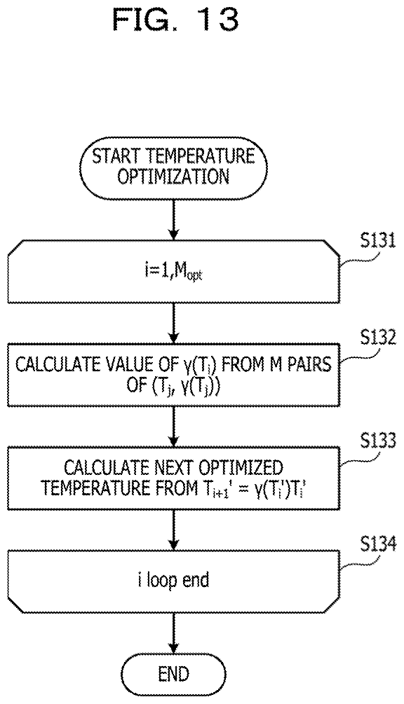

The greater the preliminary computation step number N, the greater the accuracy of the expectation value of the energy. On the other hand, when the preliminary computation step number N is too great, the computation time becomes too long. For this reason, the preliminary computation step number N is properly a value sufficiently small for performing the temperature optimization. For example, the user inputs the preliminary computation step number N=10⁶. With such a preliminary computation step number N at least, it is possible to obtain the energy value in the thermal equilibrium state to allow the energy value of the energy function to be in the thermal equilibrium state. The setting reading unit 122 transmits the read preliminary computation step number N to the control unit 121.

[step S103] The setting reading unit 122 reads the specific heat computation temperature rows that are a list of the multiple temperatures Tⱼ (j=1, 2, . . . , M) for the specific heat computation from the storage unit 110. The specific heat computation temperature Tⱼ is a value inputted by the user in advance. For example, the user inputs the discrete point of the temperature at which the specific heat is computed as the specific heat computation temperature Tⱼ in the form of list. The setting reading unit 122 transmits the read temperature row of the temperature Tⱼ of the specific heat computation to the control unit 121. In this process, the control unit 121 computes the number M of the specific heat computation temperature Tⱼ.

[step S104] The setting reading unit 122 reads the number Mₒₚₜ of the temperature rows after the optimization from the storage unit 110. The number Mₒₚₜ of the temperature rows after the optimization is a value inputted by the user in advance. The setting reading unit 122 transmits the read number Mₒₚₜ to the control unit 121.

[step S105] The setting reading unit 122 reads the value of the global minimum T₁′ of the temperature rows to be optimized from the storage unit 110. The global minimum T₁′ of the temperature rows to be optimized is a value inputted by the user in advance. The setting reading unit 122 transmits the read value of the global minimum T₁′ to the control unit 121.

[step S106] The control unit 121 causes the specific heat computation unit 124 to compute the specific heats at the temperatures indicated in the specific heat computation temperature rows. For example, the control unit 121 transmits the information such as the replica exchange probability coefficient Δ₀, the preliminary computation step number N, the specific heat computation temperature rows (temperature Tⱼ (j=1, 2, . . . , M)), and the global minimum T₁′ of the temperature rows to be optimized to the specific heat computation unit 124. The specific heat computation unit 124 reads the information to be used for the energy computation of the replica from the storage unit 110 and performs the specific heat computation processing. The details of the specific heat computation processing are described later (see FIG. 12).

[step S107] The control unit 121 causes the temperature optimization unit 125 to execute the optimization processing of the temperature to be set for the replica. For example, the control unit 121 transmits the specific heat of each specific heat computation temperature computed by the specific heat computation unit 124 to the temperature optimization unit 125. Based on the specific heat of each specific heat computation temperature, the temperature optimization unit 125 computes the temperature proper to be set for the replica. The details of the temperature optimization processing are described later (see FIG. 13).

[step S108] The control unit 121 causes the energy optimization unit 126 to execute the energy optimization processing. For example, the control unit 121 transmits the value of the temperature computed by the temperature optimization unit 125 to the energy optimization unit 126. The energy optimization unit 126 sets the obtained temperature to the temperature of the replica, executes the simulation of the solution problem by the replica exchange method, and calculates the global minimum of the energies.

Next, the details of the specific heat computation processing are described.

FIG. 12 is a flowchart illustrating an example of the procedures of the specific heat computation processing. Hereinafter, the processing illustrated in FIG. 12 is described along the step numbers.

[step S121] The specific heat computation unit 124 increments the values of the variables j indicating the order of the temperatures in the specific heat computation temperature rows from 1 to M by one, and executes the processing of steps S122 and S123 for each of the values set to the variables j.

[step S122] The specific heat computation unit 124 causes the energy optimization unit 126 to execute the sampling computation of the Ising model at the temperature Tⱼ N times. For example, the specific heat computation unit 124 requests the control unit 121 to perform the N times of the sampling computation at the specific heat computation temperature Tⱼ. The control unit 121 then instructs the energy optimization unit 126 to perform the sampling computation.

The energy optimization unit 126 obtains the spin information, the replica information, the temperature information, the problem setting information, the Hamiltonian information, and the like from the storage unit 110. The energy optimization unit 126 then performs the computation of the energy of the Ising model N times by the Metropolis-Hastings algorithm according to Expression (1). The energy value obtained by the sampling computation as described above is alleviated to the thermal equilibrium state determined based on each specific heat computation temperature Tⱼ. Every time performing the computation of the energy, the energy optimization unit 126 stores the calculated energy value to the storage unit 110. The aggregation of the stored energy values is an example of the thermal equilibrium state information 11b illustrated in FIG. 1. Once the N times of computation is terminated, the energy optimization unit 126 notifies the control unit 121 of the termination of the sampling computation. The control unit 121 notifies the specific heat computation unit 124 of the completion of the sampling computation.

[step S123] The specific heat computation unit 124 computes the average value <Eⱼ> and the squared average value <Eⱼ²> of the energies in the equilibrium state and computes the specific heat Cᵥ(Tⱼ) by Expression (25). The specific heat computation unit 124 then computes the value of the temperature interval coefficient γ(Tⱼ) by Expression (20).

[step S124] Once the processing of steps S122 and S123 for each of the values of the variables j from 1 to M is terminated, the specific heat computation unit 124 terminates the specific heat computation processing. Thereafter, the specific heat computation unit 124 transmits the specific heat Cᵥ(Tⱼ) and the temperature interval coefficient γ(Tⱼ) of each specific heat computation temperature Tⱼ to the control unit 121 as the computation result.

Once the specific heat computation processing is terminated, the control unit 121 transmits the specific heat Cᵥ(Tⱼ) and the temperature interval coefficient γ(Tⱼ) of each specific heat computation temperature Tⱼ to the temperature optimization unit 125 and causes the temperature optimization unit 125 to execute the temperature optimization processing.

FIG. 13 is a flowchart illustrating an example of the procedures of the temperature optimization processing. Hereinafter, the processing illustrated in FIG. 13 is described along the step numbers.

[step S131] The temperature optimization unit 125 increments the values of the variables i indicating the order of the values of the temperatures after the optimization from 1 to Mₒₚₜ by one and executes the processing of steps S132 and S133 for each of the values set to the variables i.

[step S132] The temperature optimization unit 125 calculates the value of γ(Tᵢ) from the M pairs of (Tⱼ, γ(Tⱼ)). For example, the temperature optimization unit 125 performs the interpolation computation by using Expression (26) based on the M pairs of (Tⱼ, γ(Tⱼ)) to calculate the value of γ(Tᵢ).

[step S133] The temperature optimization unit 125 calculates the next optimized temperature Tᵢ₊₁′. The next optimized temperature Tᵢ₊₁′ may be computed as Tᵢ₊₁′=γ(Tᵢ′)Tᵢ′ based on Expression (19).

[step S134] Once the processing of steps S132 and S133 for each of the values of the variables i from 1 to Mₒₚₜ is terminated, the temperature optimization unit 125 terminates the temperature optimization processing. Thereafter, the temperature optimization unit 125 transmits the optimized temperature Tᵢ′ (i=1, 2, . . . , Mₒₚₜ) to the control unit 121 as the computation result.

According to the above-described temperature optimization processing, the optimized temperatures are determined in ascending order of temperature. Thereafter, the energy optimization unit 126 sets the optimized temperatures to the temperatures of the replicas, and the simulation by the replica exchange method is executed. The optimized temperatures have the temperature interval widths that allow the replica exchange probability to be fixed. Thus, in the simulation by the energy optimization unit 126, each replica may properly perform the random walk in the temperature space. Consequently, it is possible to obtain a heuristically low energy optimum value.

Hereinafter, a specific example of the optimization of the temperatures is described.

Here is assumed the traveling salesman problem including 16 cities as an example problem. The traveling salesman problem is a combinatorial optimization problem in which an aggregation of the cities and the moving costs between the cities are given to find a path of the minimum total moving cost for traveling each of all the cities once. If the optimizer 100 is able to obtain a proper solution of the traveling salesman problem, it is possible to obtain proper solutions for various social scientific problems such as delivery route optimization by using the optimizer 100.

With Expression (20) applied to the traveling salesman problem, the specific heat computation unit 124 of the optimizer 100 calculates the specific heat as illustrated in FIG. 8. The specific heat computation unit 124 calculates the temperature interval coefficient γ(T) from the calculated specific heat by using Expression (20). For example, the replica exchange probability coefficient with which the lowest temperature of T₀=1.0 and the replica exchange probability of “0.9” are obtained is set to Δ₀≈N 0.0458. When the temperature interval coefficient γ(T) of the above-described traveling salesman problem is computed under this condition, the temperature interval coefficient γ(T) substantially the same as that of the case of Δ₀=0.5 illustrated in FIG. 9 is obtained.

In this case, if the optimization is performed with the number of the replicas set as “5” (Mₒₚₜ=5), the temperature rows as described below are obtained.

<Optimized Temperature Rows (Optimization Example)> {T₀, T₁, T₂, T₃, T₄}={1.0, 5.055, 13.349, 28.354, 32.677}

As a comparative example, here are indicated below the temperature rows to be set for the replicas when the temperature optimization is not performed.

<Temperature Rows with No Optimization (First Comparative Example)> {T₀, T₁, T₂, T₃, T₄}={1.0, 20.0, 40.0, 60.0, 80.0}

The comparative example assumes a case in which the user has no previous knowledge about the specific heat and no standard for selecting the temperature. When the user has no previous knowledge, it may be estimated that the user sets the temperature rows at regular intervals as indicated by the comparative example.

In order to see whether the efficiency of obtaining an energy global minimum candidate by the temperature optimization is significantly improved more than a case of using another sampling method, the temperature optimization is compared with the dynamic offset method. The dynamic offset method is a method used when solutions (pairs of state variables) are trapped and unable to escape from the local minima of the energies in the global minimum problem of multivariable functions. For example, the dynamic offset method allows the solutions to escape forcibly from the energy local minima by adding fixed values to the values of the energies. It has been known that the solutions are not trapped by the energy local minima and the global minimum candidate of the energies may be efficiently obtained by using the dynamic offset method.

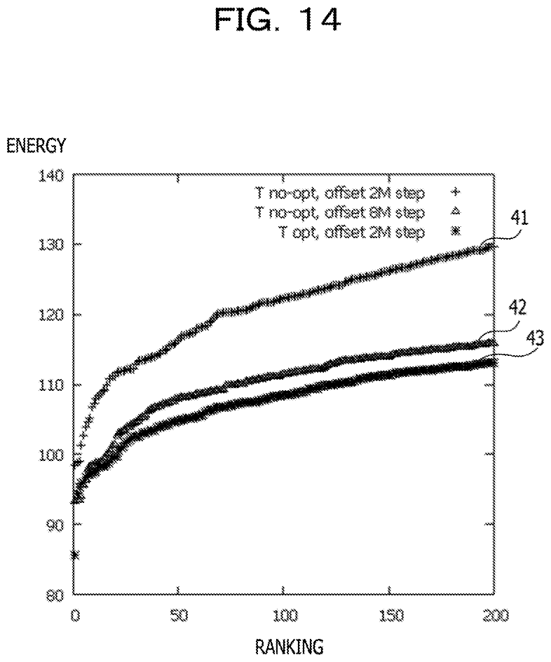

FIG. 14 is a diagram illustrating an example of comparing solutions of the cases in which the number of computation steps is increased and the case in which the temperature optimization is performed. A first case 41 is an example of using the temperature rows indicated by the above-described first comparative example to obtain the global minimum with the number of times of computation set to two million times. A second case 42 is an example of using the temperature rows indicated by the above-described first comparative example to obtain the global minimum with the number of times of computation set to eight million times. A third case 43 is an example of using the temperature rows indicated by the above-described optimization example to obtain the global minimum with the number of times of computation set to two million times.

In FIG. 14, the horizontal axis represents a ranking within the same case when the energies for the solutions obtained in each case are ranked in ascending order. The vertical axis represents a value of the energy of the solution of each ranking. The dynamic offset method is concurrently used in all the cases. This is for quantitatively indicating only the effect of the temperature optimization under the situation in which the solutions are not trapped by the local minima.

As illustrated in FIG. 14, in the third case 43 in which the temperature optimization is performed, there is obtained a solution of lower energy than that of the first case 41 in which the number of times of computation is the same and the temperature optimization is not performed. In the second case 42 in which the number of times of computation is four times greater and the temperature optimization is not performed, the obtained solution of the energy is lower than that of the first case but is not low as that of the third case 43. For example, in order to obtain a solution comparable with the solution of the third case 43 without performing the temperature optimization, the number of times of computation has to be four times greater. In other words, the computation efficiency is four or more times greater by performing the temperature optimization. Accordingly, the following conclusions are obtained.

<Conclusion 1> With the temperature optimization performed, the energy global minimum and the energy value of a suboptimal solution (good solution) obtained by the simulation are significantly decreased.

<Conclusion 2> With the temperature optimization performed, the computation amount for obtaining the energy global minimum and the suboptimal solution (good solution) is smaller than the case of not performing the temperature optimization.

Next, results of obtaining the global minimum from a case in which the number of the replicas is increased and from a case in which the temperature optimization is performed are compared with each other. As an example of the case of increasing the number of the replicas, the following temperature rows with no optimization are used.

<Temperature Rows with No Optimization (Second Comparative Example)> {T₀, T₁, T₂, T₃, T₄, T₅, T₆, T₇, T₈, T₉, T₁₀, T₁₁, T₁₂, T₁₃, T₁₄, T₁₅, T₁₆}={1.0, 5.0, 10.0, 15.0, 20.0, 25.0, 30.0, 35.0, 40.0, 45.0, 50.0, 55.0, 60.0, 65.0, 70.0, 75.0, 80.0}

The second comparative example is temperature rows to be set for the respective replicas when the number of the replicas is 17. The temperatures in the temperature rows are temperatures at regular intervals like the first comparative example.

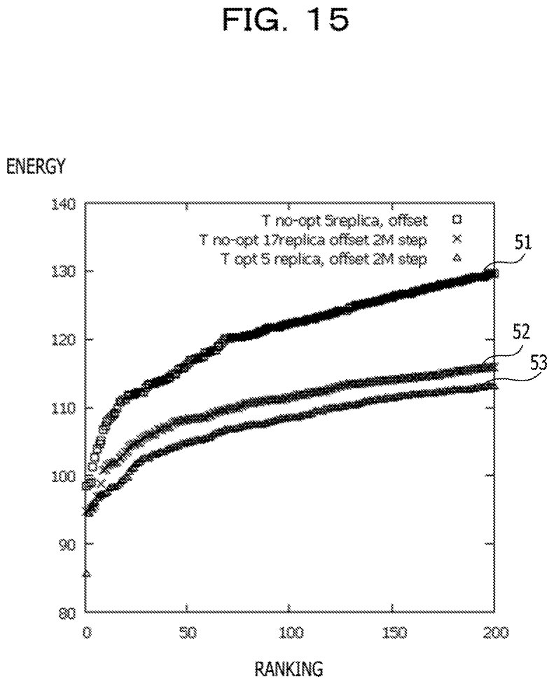

FIG. 15 is a diagram illustrating an example of comparing solutions of the cases in which the number of replicas is increased and the case in which the temperature optimization is performed. A fourth case 51 is an example in which the global minimum is obtained by five replicas using the temperature rows indicated by the above-described first comparative example. A fifth case 52 is an example in which the global minimum is obtained by 17 replicas using the temperature rows indicated by the above-described second comparative example with two million times of computation. A sixth case 53 is an example in which the global minimum is obtained by five replicas using the temperature rows indicated by the above-described optimization example with two million times of computation. In all the cases, the number of times of computation is two million times, and the trial frequency for exchanging the replicas is once every ten times of computation.

In FIG. 15, the horizontal axis represents a ranking within the same case when the energies for the solutions obtained in each case are ranked in ascending order. The vertical axis represents a value of the energy of the solution of each ranking. The dynamic offset method is concurrently used in all the cases.

As illustrated in FIG. 15, in the sixth case 53 in which the temperature optimization is performed, there is obtained a solution of lower energy than that of the fourth case 51 in which the temperature optimization of the number of times corresponding to the number of the replicas is not performed. In the fifth case 52 in which the number of replicas is increased to 17 without performing the temperature optimization, the obtained solution of the energy is lower than that of the fourth case 51 but is not low as that of the sixth case 53. For example, in the sixth case 53 in which the temperature optimization is performed, even with the five corollaries, there is obtained an energy global minimum candidate better than that of the fifth case 52 in which the number of the replicas is increased to 17. Accordingly, the following conclusions are obtained.

<Conclusion 3> With the replica exchange temperature optimized, it is possible to reduce the number of the replicas to be used.

The number of the replicas is substantially proportional to the computation amount Thus, for example, if the number of the replicas is able to be reduced from 17 to five, it is possible to reduce the computation amount to one-third or less.

As described above, the following technical effects are obtained by using the optimizer 100 capable of optimizing the temperature of the replica exchange. 1. Obtainment of a solution of high accuracy by a proper random walk of the replica during the obtainment of the global minimum by the replica exchange method. 2. Reduction of computation sources used for the obtainment of the global minimum by the replica exchange method. 3. Reduction of the computation time for the obtainment of the global minimum by the replica exchange method. 4. Reduction of works of the user by the automatic determination of a temperature row of a replica optimal for the obtainment of the global minimum by the replica exchange method.

### Third Embodiment

Next, a third embodiment is described. The third embodiment is for improving the accuracy of the temperature to be set for the replica. For example, in the third embodiment, the accuracy of the temperature to be set for the replica is improved by repeating the specific heat computation in the optimizer 100.

The optimizer 100 automatically determines the temperature row proper for implementing the random walk in the replica exchange method from the computation of the specific heat. On the other hand, the accuracy of the optimized temperature depends on the preliminary computation executed for computing the specific heat.

Since the temperature is not optimized during the preliminary computation, the temperature of the sampling used for the preliminary computation (step S122 in FIG. 12) is not the best Thus, the accuracy of the specific heat is also an approximation. In order to improve the accuracy of the specific heat, it is important to set a proper sampling temperature in the preliminary computation. The proper sampling temperature in the preliminary computation is a temperature at which the specific heat is able to be calculated correctly during the calculation of the temperature interval coefficient γ(T) in the temperature optimization (step S132 in FIG. 13).

For example, with the preliminary computation performed by using the temperature optimized as the temperature of the replica in the temperature optimization processing, it is possible to inhibit the error as minimum as possible due to the obtainment of the specific heat by the interpolation when calculating the temperature interval coefficient γ(T). For example, with the preliminary computation performed while using the optimized temperature row as the specific heat computation temperature row, the accuracy of the specific heat used for the computation of the temperature interval coefficient γ(T) is improved, and the accuracy of the optimized temperature is also improved.

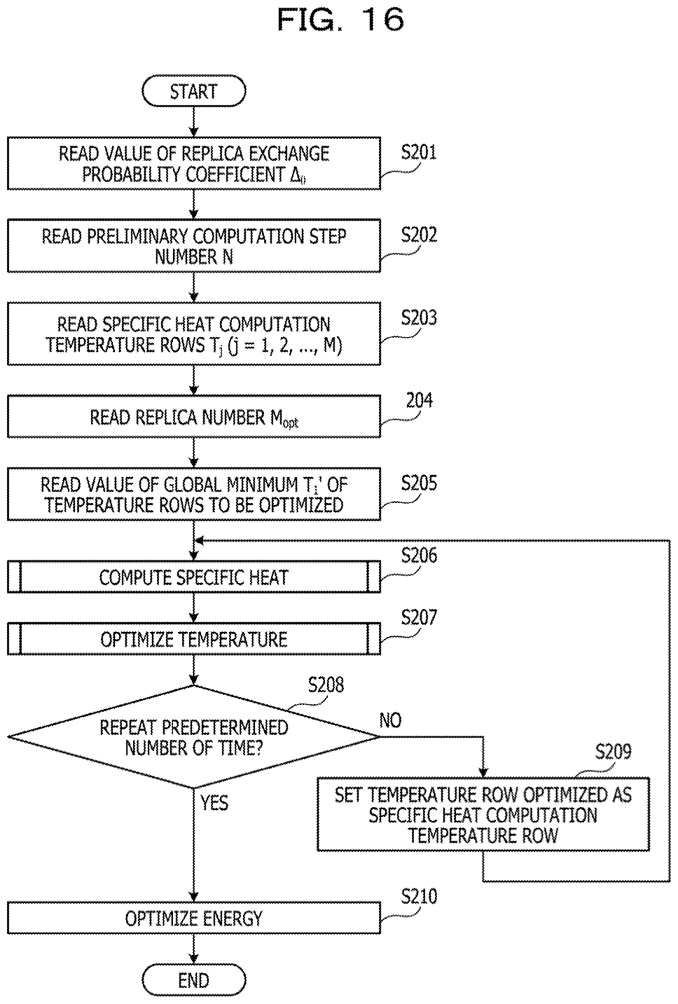

FIG. 16 is a flowchart illustrating an example of the procedures of the energy global minimum obtainment processing in the third embodiment. Steps S201 to S207 and S210 in the processing illustrated in FIG. 16 are similar to the processing of steps S101 to S108 of the processing of the second embodiment illustrated in FIG. 11, respectively. Hereinafter, the processing of steps S208 and S209 different from the second embodiment is described.

[step S208] The control unit 121 determines whether the processing of determining the temperature of the replica in steps S206 and S207 is repeated a predetermined number of times. When the processing is repeated a predetermined number of times, the control unit 121 causes the process to proceed to step S210. When the processing is not repeated a predetermined number of times, the control unit 121 causes the process to proceed to step S209.

[step S209] The control unit 121 sets the temperature row optimized in step S207 as the specific heat computation temperature row. Thereafter, the control unit 121 causes the process to proceed to step S206.

As described above, the optimizer 100 is able to improve the accuracy of the temperature optimization by evaluating again the specific heat using the optimized temperature row and by repeatedly executing the optimization of the temperature by the specific heat with improved accuracy. When the accuracy of the optimization of the temperature of the replica is improved, the probability that the random walk is performed is increased, and the accuracy of the energy global minimum candidate (good solution) is also improved.

### OTHER EMBODIMENTS

The optimizer 100 is able to perform the simulation by combining the dynamic offset method with the replica exchange method with the optimized temperature. With the dynamic offset method combined with the replica exchange method, it is possible to obtain a heuristically lower energy.

As described in the second embodiment, the replica exchange probability is determined by only the energy and the temperature row. Therefore, it is possible to use the temperature optimization in the replica exchange method implemented by the optimizer 100 also for obtaining various optimization problems other than the Ising model and the traveling salesman problem.

For example, the molecular dynamics method is frequently used in the field of computational chemistry. Although the replica exchange method is also used in the molecular dynamics method, the optimization of the temperature of the replica in the replica exchange method is important as the Ising model. The replica exchange probability is determined based on the temperature and the energy and does not depend on whether the state variable is discrete or continuous. Thus, if the user gives at least the sampling information of the energy value at each dock time to the optimizer 100 at each temperature, it is possible to obtain the temperature row with which the replica exchange is optimized by a logic same as that of the case of Ising model.

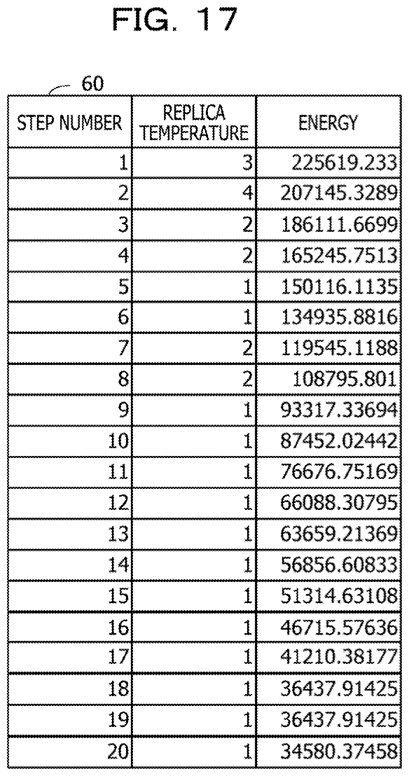

FIG. 17 is a diagram illustrating an example of sampling information for obtaining a temperature row with which the replica exchange is optimized. In sampling information 60, the replica temperature and the energy are set for each number of steps of simulation for the sampling. With such sampling information 60, the optimizer 100 is able to obtain the specific heat of each temperature and to perform the temperature optimization of the replica in the replica exchange method. The sampling information 60 is an example of the thermal equilibrium state information 11b in the first embodiment illustrated in FIG. 1.

Although the embodiments are exemplified as described above, the configurations of the units described in the embodiments may be replaced with others having similar functions. Another arbitrary constituent or step may be added. Arbitrary two or more configurations (characteristics) of the above-described embodiments may be combined with each other.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optimizer, comprising:
a memory; and
a processor coupled to the memory and configured to:
obtain specific heat information indicating a relationship between a specific heat indicating a degree of variation of energy according to a temperature variation and a temperature, and
determine a plurality of temperature values to be respectively set for a plurality of replicas when an optimum value of energy functions is obtained by a replica exchange method based on the specific heat information.

2. The optimizer according to claim 1, wherein
the memory is further configured to store thermal equilibrium state information indicating an energy value in a thermal equilibrium state at each of a plurality of sample temperature values of the energy functions in a solution problem for obtaining the optimum value of the energy functions, and
the processor calculates the specific heat information based on the thermal equilibrium state information.

3. The optimizer according to claim 2, wherein
the processor generates, as the specific heat information, an interpolation formula for interpolating the specific heats respectively corresponding to two sample temperature values adjacent to each other when the plurality of sample temperature values are arranged in the order of the magnitude of the values.

4. The optimizer according to claim 2, wherein
the processor repeats computation of the energy functions at the respective plurality of sample temperature values and stores the energy values after being set in the thermal equilibrium state in the memory as the thermal equilibrium state information.

5. The optimizer according to claim 4, wherein
after determining the plurality of temperature values, the processor changes the plurality of sample temperature values to values same as the determined temperature values, repeats the computation of the energy functions at the respective plurality of sample temperature values after the changing, and updates the thermal equilibrium state information based on the energy values after being set in the thermal equilibrium state.

6. The optimizer according to any one of claim 1, wherein
the processor determines the plurality of temperature values such that an interval between temperature values in a first temperature range is narrower than an interval between temperature values in a second temperature range in which the specific heat is smaller than that of the first temperature range.

7. The optimizer according to claim 6, wherein
the processor calculates a temperature interval width corresponding to the specific heat at an m-th temperature value (m is an integer of 1 or greater) In the ascending order of temperature based on a temperature interval width calculation formula in which a value is smaller as the specific heat is greater, and determines a temperature higher than the m-th temperature value by the calculated temperature interval width as an m+1-th temperature value in the ascending order of temperature.

8. The optimizer according to any one of claim 1, wherein
the processor also sets the plurality of temperature values for the plurality of replicas respectively and obtains the optimum value of the energy functions by the replica exchange method.

9. An optimization method executed by a computer, the optimization method comprising:
obtaining specific heat information indicating a relationship between a specific heat indicating a degree of variation of energy according to a temperature variation and a temperature; and
determining a plurality of temperature values to be respectively set for a plurality of replicas when an optimum value of energy functions is obtained by a replica exchange method based on the specific heat information.

10. A non-transitory computer-readable storage medium storing a program that causes an information processing apparatus to execute a process, the process comprising:
obtaining specific heat information indicating a relationship between a specific heat indicating a degree of variation of energy according to a temperature variation and a temperature; and
determining a plurality of temperature values to be respectively set for a plurality of replicas when an optimum value of energy functions is obtained by a replica exchange method based on the specific heat information.
